(19) United States
(12) Patent Application Publication
(10) Pub. No.: US 2006/0064470 A1
(43) Pub. Date: Mar. 23, 2006

(54) Method, system, and computer program product for improved synchronization efficiency for mobile devices, including database hashing and caching of web access errors

(76) Inventors: Antony John Sargent, Menlo Park, CA (US); Duane Scott Hess, Cupertino, CA (US); Ramandeep Sethi, Fremont, CA (US); Michael Tsao, San Mateo, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/947,351

(22) Filed: Sep. 23, 2004

(51) Int. Cl. G06F 15/16

(52) U.S. Cl. 709/219

(57) ABSTRACT

Methods, systems, apparatuses, and computer program products for improving efficiency in transfer of content to mobile devices are provided. In a first aspect, hashing is used in a synchronization server to determine whether objects have changed, and therefore need to be updated on the mobile device and/or on the mobile device server. For example, databases are hashed on a record-by-record basis. Records determined to be changed are transmitted to the mobile device and/or updated on the synchronization server. In another embodiment, errors occurring during attempts to obtain unavailable web content are cached (i.e., “negative caching”). The cached errors are accessed during subsequent attempts to obtain the unavailable web content to avoid spending time on the subsequent attempts.

### BACKGROUND OF THE INVENTION

1. Field of the Invention

The present invention relates to mobile handheld devices, and in particular, to improving the efficiency of synchronizations with mobile handheld devices.

2. Background Art

A variety of mobile devices (such as personal data assistants, or PDAs) exist. Web content (as well as other objects) can be loaded on mobile devices for users of mobile devices to view and interact with such web content on their mobile devices while in an offline mode (i.e., not connected to the Web). Thus, requests for web content can be made by a mobile device to a mobile device server. The mobile device server obtains the web content from providers, and transfers the web content to the mobile device. The web content can be transferred to the mobile device during a synchronization of data. For data stored in record format, fields in the records are compared during synchronization.

It is desirable for the transfers of web content to mobile devices to occur rapidly, so that offline usage time of the mobile device can be maximized. Furthermore, a rapid transfer of web content to a mobile device frees the mobile device server to synchronize other mobile devices, and/or to perform other functions. Thus, methods and systems for improving efficiency in transfer of content to mobile devices for offline use are desired.

### BRIEF SUMMARY OF THE INVENTION

In aspects of the present invention, methods, systems, apparatuses, and computer program products for improvements in the efficiency of transfer of content to mobile devices are provided.

In a first aspect of the present invention, a first mobile device is synchronized by a server. A request for a web-based object is received from the first mobile device. The request for the web-based object is transmitted to a provider. A response to the transmitted request is determined to have not been received from the provider. Information indicating that the response was not received is cached in the server.

In a further aspect, the cached information is transmitted to the first mobile device.

In a further aspect, a second mobile device is synchronized by the server. A request for the web-based object is received from the second mobile device. The cached information is transmitted to the second mobile device without servicing the request for the web-based object.

In a further aspect, the cached information is cleared in the server after a predetermined interval of time has expired.

In another aspect of the present invention, a server includes an error caching module. The error caching module caches information related to a request for a web-based object transmitted to a provider if a response to the request is not received from the provider. The server transmits the cached information to the mobile device during the synchronization with the mobile device. The error caching module clears the cached information after expiration of a predetermined amount of time. The server transmits the cached information to another mobile device during a synchronization with the another mobile device if a subsequent request for the web-based object is made by the another mobile device before expiration of the predetermined amount of time.

In another aspect of the present invention, a server synchronizes a mobile device. A synchronization request is received from the mobile device. Due to the synchronization request, a database object is obtained from a provider. The database object includes a plurality of records, each record containing one or more fields. Each record of the database object is hashed to calculate a hash result for each record. The calculated hash result for each record is compared with a corresponding previous hash result, if available. For each record, if the calculated hash result matches the corresponding previous hash result, no update regarding that record of the database object is needed. For each record, if the calculated hash result does not match the corresponding previous hash result or the corresponding previous hash result is not available, the entire record is transmitted to the mobile device.

In a further aspect, for each record, if the calculated hash result does not match the corresponding previous hash result or the corresponding previous hash result is not available, the calculated hash result is stored.

In a still further aspect of the present invention, a server is described that synchronizes a mobile device. The server includes a synchronization module, a hashing module, and a comparator. The synchronization module receives a synchronization request from the mobile device, and obtains channels from at least one provider due to the synchronization request. An obtained channel includes a database object. The database object includes a plurality of records. The hashing module hashes each record of the database object to calculate a hash result for each record. The comparator compares the calculated hash result for each record with a corresponding previous hash result, if available. For each record, if the calculated hash result matches the corresponding previous hash result, then the synchronization module does not need to transmit an update of that record of the database object to the mobile device in a response to the synchronization request. For each record, if the calculated hash result does not match the corresponding previous hash result or the corresponding previous hash result is not available, then the synchronization module transmits the record to the mobile device in a response to the synchronization request.

These and other objects, advantages and features will become readily apparent in view of the following detailed description of the invention.

### BRIEF DESCRIPTION OF THE DRAWINGS/FIGURES

The accompanying drawings, which are incorporated herein and form a part of the specification, illustrate the present invention and, together with the description, further serve to explain the principles of embodiments of the invention and to enable a person skilled in the pertinent art to make and use the invention.

FIGS. 1 and 2 show block diagrams of example mobile computing environments, according to embodiment of the present invention.

FIG. 3 shows an example server with hashing capability, according to an embodiment of the present invention.

FIG. 4 shows an example database file that can be hashed by a hashing module, according to an embodiment of the present invention.

FIG. 5 shows a flowchart relating to an example embodiment where each record of a database file is individually hashed, according to an example embodiment of the present invention.

FIG. 6 shows example operation of an embodiment of the present invention on a row of an example database file.

FIG. 7 shows an example server with negative caching capability, according to an embodiment of the present invention.

FIGS. 8A-8C show flowcharts providing example steps in a server for synchronizing mobile devices, according to example embodiments of the present invention.

The present invention will now be described with reference to the accompanying drawings. In the drawings, generally, like reference numbers indicate identical or functionally/structurally similar elements. Additionally, generally, the left-most digit(s) of a reference number identifies the drawing in which the reference number first appears.

### DETAILED DESCRIPTION OF THE INVENTION

### Introduction

The present invention provides improvements in the efficiency of transfer of content to mobile devices. In a first embodiment, hashing is used to determine whether objects have changed, and therefore need to be updated on the mobile device and/or on the mobile device server. In another embodiment, errors occurring during the obtaining of unavailable web content are cached (i.e., “negative caching”). The cached errors are used to avoid wasting time on future attempts at obtaining the unavailable web content, thus decreasing synchronization times for subsequent device synchronizations.

Further description of embodiments of the present invention is provided in the sections below. The following section describes example environments for the present invention. The subsequent sections describe embodiments for data/object hashing, and embodiments for negative caching.

### Example Environment of the Present Invention

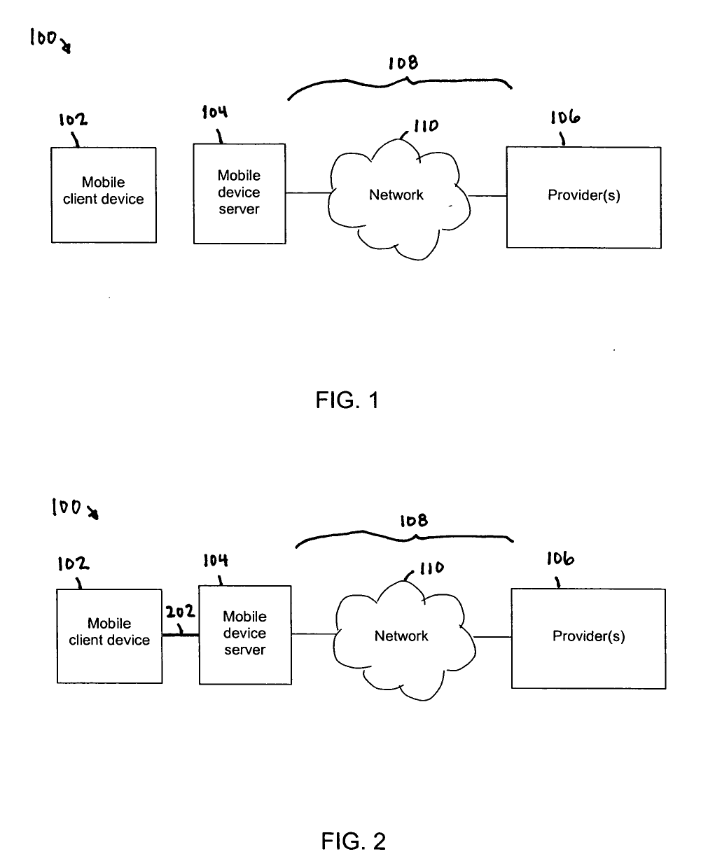

FIG. 1 is a block diagram of an example mobile computing environment 100 according to an embodiment of the invention. The mobile computing environment 100 includes a mobile client device 102, a mobile client server 104 (although only one mobile client server 104 is shown, in practice mobile computing environment 100 may include a plurality of such servers), and one or more providers 106.

Generally, mobile client server 104 maintains a collection of channels. In an embodiment, a channel comprises a collection of objects. An object is any entity or data that can be transferred to a mobile client device 102, such as but not limited to a web pages, content, applications, application data, services, images, movies, music, links, etc. A channel can include a location of a root object, such as but not limited to a URL (uniform resource locator), and an indication of the number of levels below the root object, for which to include objects in the channel. For example, in an embodiment, if a channel number property is equal to “1 level,” then all objects that are 1 level down from the root object (reached by traversing links in the root object), are included in the channel. If this property is equal to “2 levels,” then all objects that are 1 level down from the root object (reached by traversing links in the root object), and all objects that are 1 level down from those objects (reached by traversing links in those objects), are included in the channel.

For example, the root object for a first channel may be a first web page, and the channel property may be equal to “1 level.” Mobile client server 104 obtains and parses the first web page for objects that are 1 level down from the first web page. For instance, mobile client server 104 may locate a first link to an image file, and an associated second link used when the image of the image file is selected in a web page (i.e., a “destination” link). For example, the second link may be a link to a second web page. Mobile client server 104 traverses the first and second links to gather copies of the image file and second web page, respectively, for inclusion in the channel. The channel can subsequently be transferred to mobile client device 102, including transfer of the first and second web pages, and the image file.

Embodiments of the invention allow “uneven” trees, where some branches of the tree extend to a greater number of levels than other branches of the tree. In other embodiments, the trees are even or balanced.

Mobile client server 104 offers channels to mobile client device 102. Mobile client device 102 may access mobile client server 104 and view the collection of channels. The mobile client device 102 may then select any combination of the channels in the collection. Mobile client server 104 maintains a list of the channels associated with mobile client device 102.

As shown in FIG. 1, mobile client device 102 is not coupled to mobile client server 104. Thus, in FIG. 1, mobile client device 102 is operating in an “offline” mode. Mobile client device 102 and mobile client server 104 may be coupled together to perform a synchronization process. The synchronization process of the invention includes various synchronization processes/operations that can collect information from the Internet to a server, and to the client. The usage of the term “sync” or “synchronization process” as described herein, refers to the overall operation of connecting a client to a server for the exchange, interaction, creation, and removal of data.

In one embodiment, syncing can be defined as mirroring data on a client and a server, such that the data is the same on client and server. In other embodiments, syncing can be defined as overwriting data on a client or on a server, such that the data on either a client replaces the data on a server, and vice versa.

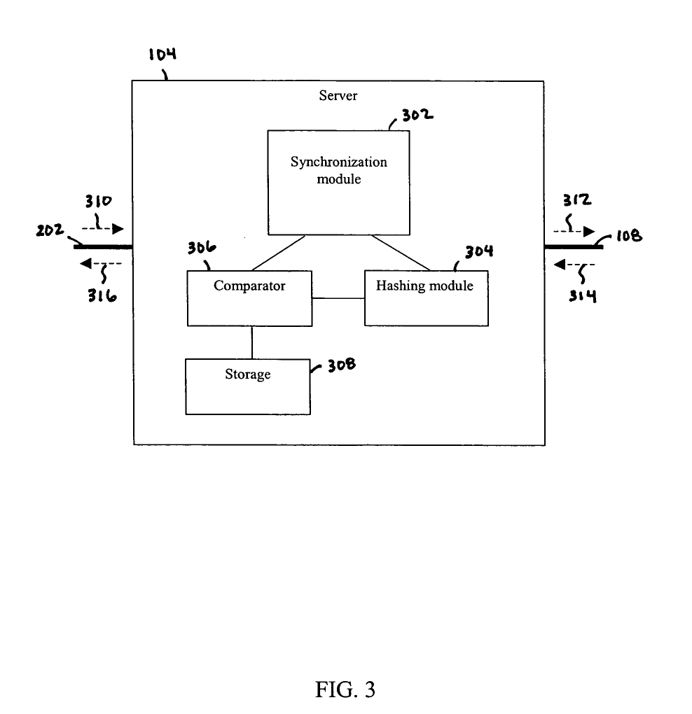

For example, FIG. 2 shows mobile client device 102 and mobile client server 104 coupled together by a communications link 202. Mobile client device 102 and mobile client server 104 may be coupled together by link 202 in either a wired or wireless manner. During a synchronization process, mobile client server 104 loads a device 102 with the channels associated with the mobile client device 102. Generally, mobile client server 104 does this by obtaining from providers 102 the objects defined by the channels, and causing those objects to be stored on the mobile client device 102. Thus, during the synchronization process, mobile client server 104 will load the mobile client device 102 with the selected channels. More particularly, mobile client server 104 will load the mobile client device 102 with the objects associated with the channels. Thus, in embodiments where mobile client server 104 performs a synchronization process, mobile client server 104 can also be referred to as a synchronization server, or “sync” server.

The mobile client device 102 may process and use those objects when not connected to the mobile client server 104 (i.e., in the “offline” mode, such as shown in FIG. 1). The mobile client device 102 can actively interact with the objects and channels in the offline mode.

Data transferred to mobile client device 102 from mobile client server 104 may be transferred without reformatting/encoding (e.g., web pages may remain in HTML format), or alternatively the data may have been reformatted and/or encoded. For example, in an embodiment, data transferred to mobile client device 102 may be encoded by mobile client server 104 in a data format called Already Been Chewed or “Already Been Compressed” (ABC), which is a tokenized version of the data. For example, ABC format creates a tokenized codification of HTML pages for transfer to mobile client device 102. ABC encoding is a mapping of parent and child HTML elements and/or resources to alphanumeric values.

For example, a first online web page may include a link to an online resource, such as another web page, http://www.yahoo.com. The first online web page may be copied to mobile client server 104, and ABC encoded by mobile client server 104 for offline use on mobile client device 102. Likewise, the referenced web page of www.yahoo.com is copied to mobile client server 104, and may be encoded. Furthermore, mobile client server 104 prepares the copied web page of www.yahoo.com to be stored in a directory of mobile client device 102. For example, the directory may be /programs/webfiles, and the copied web page of www.yahoo.com may be renamed as “AAAyahoo1.” Accordingly, any links to www.yahoo.com in the encoded first web page must be changed to the offline accessible resource name. Thus, during encoding, any links to www.yahoo.com in the first web page are changed by mobile client server 104 to “/programs/webfiles/AAAyahoo1.” The first web page and AAAyahoo1 may subsequently be transferred to mobile client device 102 for offline access.

During synchronization with mobile client server 104, mobile client device 102 is coupled with mobile client server 104. In embodiments, mobile client device 102 directly communicates with mobile client server 104 via a communications medium 110 in a wired and/or wireless fashion using any protocol. For example, device 102 may “dock” directly with mobile client server 104 in a wired fashion. In another embodiment, mobile client device 102 indirectly interacts with mobile client server 104 via an adapter (not shown in FIG. 1). For example, mobile client device 102 may be a device, such as a Palm device, and the adapter may be a cradle and a computer coupled to the cradle (e.g., mobile client device 102 is inserted into the cradle). In such an embodiment, the adapter presents itself to mobile client server 104 as a mobile client device. When mobile client server 104 sends objects to the adapter, the adapter writes those objects to mobile client device 102. In embodiments, device 102 and/or an adapter (when present) can include a Hot Sync™ Manager (in a Palm operating environment, for example), an Active Sync™ (in the Windows CE™ operating environment, for example), or Pilot Link™ (in the Unix operating environment, for example) etc. It is noted that the invention is not limited to any of the implementation examples discussed herein, and that these implementation examples are provided for illustrative purposes only.

Device 102 may be any type of data processing device. In embodiments of the invention, device 102 is a mobile computing device, although the invention is not limited to these embodiments. In such example embodiments, the device 102 may be, but is not limited to, handheld computers, cellular phones, internet-enabled phones, pagers, radios, televisions, audio devices, MP3 players, car audio systems, recorders, text-to-speech devices, bar-code scanners, net appliances, mini-browsers, personal data assistants (PDAs), etc.

In embodiments of the invention, device 102 includes software, hardware, firmware, and/or any combinations thereof to provide its functions. In an embodiment, mobile client device 102 includes a user interface (UI), a web browser, and a JavaScript engine. Other embodiments of mobile client device 102 may include alternative and/or additional modules.

The invention is also directed to computer program products comprising software stored on any computer useable medium. Such software, when executed in one or more data processing devices, causes the data processing device(s) to operate as described herein. Embodiments of the invention employ any computer useable or readable medium, known now or in the future. Examples of computer useable mediums include, but are not limited to, primary storage devices (for example, any type of random access memories), secondary storage devices (for example, hard drives, floppy disks, compact discs (CDs), ZIP disks, tapes, magnetic storage devices, optical storage devices, micro-electromechanical systems (MEMS), nanotechnological storage devices, etc.), and communication mediums (wired and wireless connections and networks, local area networks, wide area networks, intranets, etc.).

The user interface of device 102 preferably includes a graphical user interface that enables users to interact with mobile client device 102 and functions and modules provided by mobile client device 102. For example, the user interface can display web pages that have been downloaded to device 102, and can allow users to interact with the web pages. The JavaScript engine of device 102 executes objects written in the JavaScript language that operate on mobile client device 102. Web pages displayable by mobile client device 102 typically comprise a series of commands of HTML (HyperText Markup Language), XML (Extensible Markup Language), and/or other language understood by mobile web browsers.

Providers 106 are sources of various types of objects, such as but not limited to content (content providers), applications (application providers), services (service providers), etc. Providers 106 may also include servers (similar to mobile client server 104), which may provide objects such as but not limited to content, applications, services, etc.

Mobile client server 104 and providers 106 are coupled together through a communication path 108. Communication path 108 can be any type of communication link, or combination of links, wired or wireless. For example, communication path 108 can include one or more networks, including a network 110. Mobile client server 104 and application provider 106 can be located within the same computer system, or in different computer systems.

For example, mobile client server 104 can reside in a first computer system, and providers 106 can reside in a second or further computer systems. The computer systems can be workstations, personal computers, or any other computer system type. In such an arrangement, mobile client server 104 and providers 106 typically communicate through a network connection (wired, wireless, or combination). Communication path 108 can include any number of links and/or networks, including network 110. Network 110 can be any type of network, or combinations of networks, including a local area network (LAN) and/or wide area network (WAN), including an intranet and/or the Internet. Alternatively, one or more providers of providers 106 can be present in a single computer system with mobile client server 104.

### Example Embodiments for Improving Transfer Efficiency with Hashing

Embodiments of the present invention are provided in this section for enabling improved efficiency in the transfer of objects to mobile devices using object hashing. These embodiments are provided for illustrative purposes, and are not limiting. Additional operational and structural embodiments for the present invention will be apparent to persons skilled in the relevant art(s) from the description herein. These additional embodiments are within the scope and spirit of the present invention.

According to embodiments of the present invention, prior to sending an object to a mobile device, the mobile device server may determine whether the object differs from an instance of the object already resident on the mobile device. If the object is the same as that already resident on the mobile device, then the mobile device server does not send/transmit the object to the mobile device. If the object is different/has changed, the object is transmitted to the mobile device. This provides benefits by reducing the amount of files needing to be transferred, such as during a synchronization process, for example. If objects are verified to have not changed, the objects do not need to be transferred. This can shorten synchronization process completion times, for example.

In one embodiment, the mobile device server, such as server 104, compares a current version of an object versus a previously stored version of the object to determine whether an object has changed. In another embodiment, server 104 compares “hashed” versions of the current and previously stored versions of an object to determine whether the object has changed. In other words, server 104 determines whether current versions of objects already reside on mobile device 102 by using hash results. Using hashing processes to determine whether an object has changed can reduce an amount of memory/storage needed on server 104. This is because only the hash results need to be stored, not the objects themselves, for use in future comparisons. Frequently, hash results require much less storage space than objects.

In embodiments, one or more hashing operations may be performed to check whether a particular object has changed. For example, according to an embodiment, two hashing operations and comparisons can be performed to determine whether an up-to-date version of an object already resides on mobile device 102. A first hashing operation and comparison may be made to a “raw” version of the object, and a second hashing operation and comparison may be made to a “transformed” version of the object. For example, the “raw” version of an object may be a version of the object as received directly from a provider. The “transformed” version of the object may be a version of the object after encoding/reformatting and/or other optimization(s) for memory space, graphics/display capabilities of the mobile device, user preferences, etc.

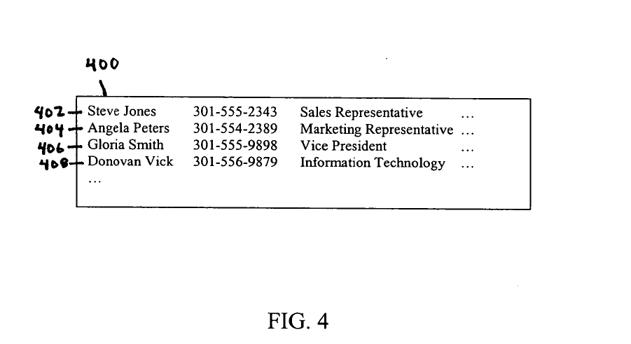

FIG. 3 shows an example server 104, with hashing capability, according to an embodiment of the present invention. As shown in the embodiment of FIG. 3, server 104 includes a synchronization module 302, a hashing module 304, a comparator 306, and a storage 308. For illustrative purposes, server 104 is described below as performing a single hashing operation to determine whether an object has changed. However, it will be apparent to persons skilled in the relevant art(s) from the teachings herein that multiple hashing operations may be performed by server 104 to verify whether objects are up-to-date.

Synchronization module 302 is used to control a synchronization process to synchronize data/objects with mobile device 102, such as further described above. For example, as shown in FIG. 3, server 104 receives a synchronization request 310 from mobile device 102. Synchronization module 302 processes synchronization request 310, and generates a request for one or more channels, which is transmitted by server 104 as channel request 312. Channel request 312 is received by one or more providers 106. Providers 106 transmit one or more channels as response 314, which is received by server 104. Synchronization module 302 processes response 314, and generates a synchronization response, which is transmitted by server 104 to mobile device 102 as synchronization response 316. Synchronization module 302 processes responses 314 by determining which objects of the received responses 314 to transmit to mobile device 102, and by reformatting, encoding, and/or transforming the objects prior to transmission as needed.

Synchronization module 302 may be implemented in software, hardware, firmware, and/or any combination thereof to provide its functions. For example, synchronization module 302 can be implemented in a software module loaded onto server 104 over a network, or from a computer compatible storage medium. Synchronization module 302 can be implemented in analog circuitry, digital circuit logic, one or more application specific integrated circuits (ASIC), and/or in software/firmware executed by a processor, etc.

In an embodiment, synchronization module 302 communicates with hashing module 304 and comparator 306 to determine whether objects need to be transmitted to mobile device 102. Hashing module 304 hashes objects to generate hash results. The hash results may be compared by comparator 306 with previous hash results stored in storage 308 to determine whether the objects have changed. If an object has changed, comparator 306 provides an indication that the object has changed to synchronization module 302. Thus, synchronization module 302 transmits to mobile device 102 the changed object in synchronization response 316.

Hashing module 304 and comparator 306 may each be implemented in software, hardware, firmware, and/or any combination thereof to provide their functions. For example, one or both can be implemented in a software module loaded onto server 104 over a network, or from a computer compatible storage medium. Furthermore, they can be implemented in analog circuitry, digital circuit logic, one or more application specific integrated circuits (ASIC), and/or in software/firmware executed by a processor, etc.

Storage 308 may be any type of storage, including physical or virtual, and long-term or short-term storage. Storage 308 can be memory such as cache memory, magnetic disk, optical disk, etc.

Any type of objects, or portion of an object, may be hashed by hashing module 304. For example, web pages, databases, any other web content, and any portions thereof, can be hashed by hashing module, and then compared to determine whether they have changed. For example, a portion of a database may be hashed by hashing module 304, and compared by comparator 306 with a corresponding previously hashed portion of the database to determine whether it have changed.

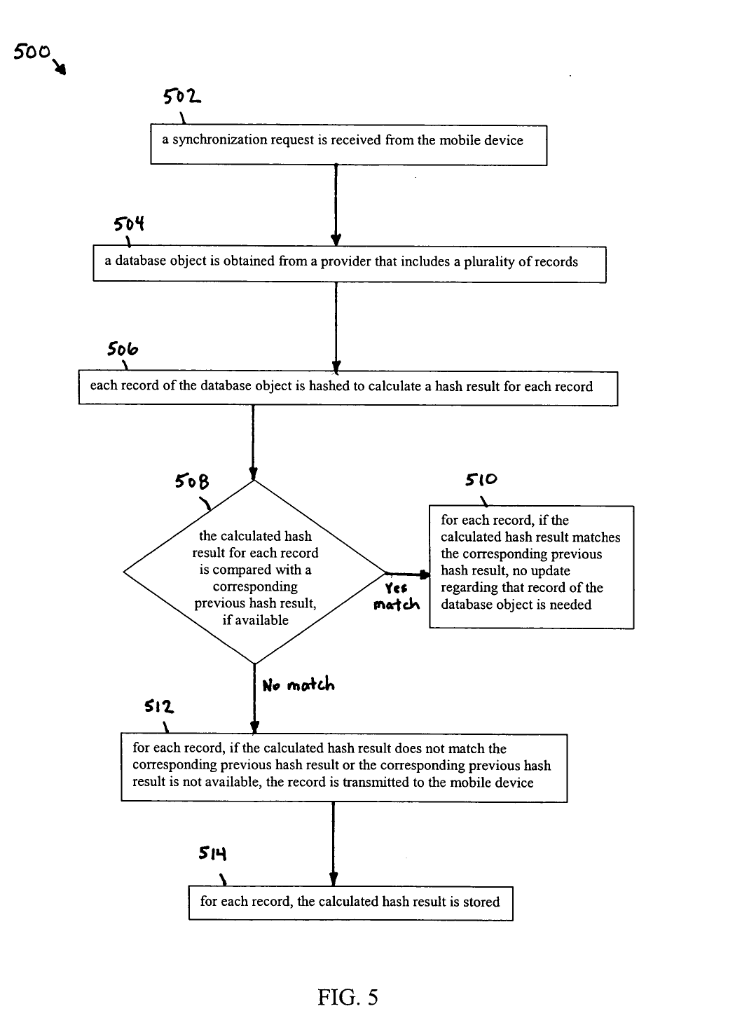

For example, FIG. 4 shows an example database file 400 that can be hashed by hashing module 304, according to an embodiment of the present invention. Database file 400 includes a plurality of records (rows) 402, 404, 406, and 408, each including various data elements/fields. The example of database file 400 shown in FIG. 4 includes a first column that shows employee names, a second column that shows employee phone numbers, and a third column that shows employee positions. Any numbers of columns of data may be present, formatted in any manner, as desired by the particular application. According to embodiments of the present invention, each field of each record of database file 400 can be individually hashed, each record of database file 400 can be individually hashed, any groups of fields and/or records can be hashed, and the entirety of database file 400 can be hashed. Each of these items can then be compared with corresponding previously hashed items to determine whether changes have occurred.

Note that objects of any format can be hashed according to embodiments of the present invention. For example, database file 400 can be formatted as plain text, or according to Extensible Markup Language (XML), Hypertext Markup Language (HTML), or Standard Generalized Markup Language (SGML). Furthermore, hashing module 304 may implement any type of hashing process. For example, hashing module 304 may perform an MD5 hash. Any hash object for the hashing operations may be used. For example, global unique identifiers (GUIDs) generated by server 104 for each object may be used as hash objects.

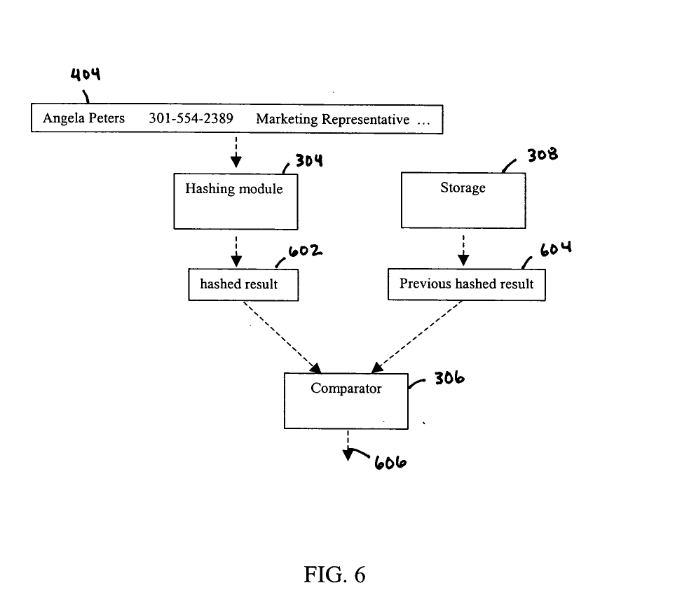

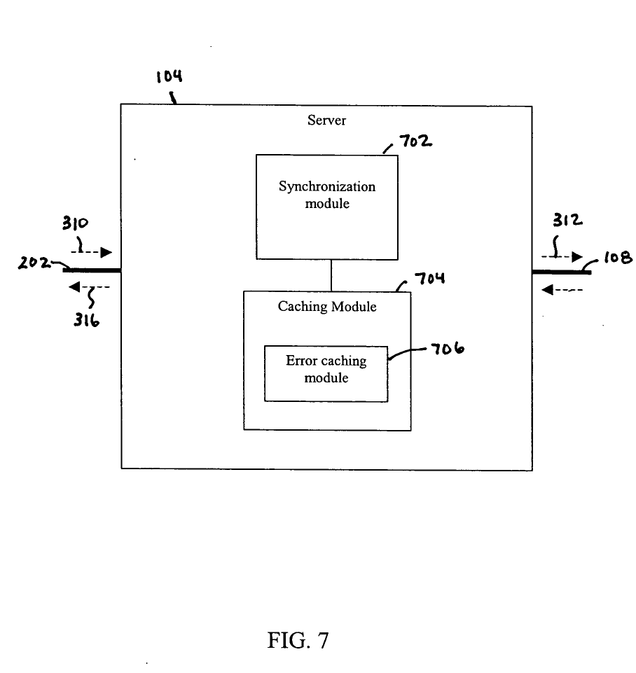

In an embodiment, a database object is hashed and compared record-by-record (row-by-row). FIG. 5 shows a flowchart 500 relating to an example embodiment where each record of database file 400 is individually hashed, according to an example embodiment of the present invention. Other structural and operational embodiments will be apparent to persons skilled in the relevant art(s) based on the following discussion. These steps are described in detail below. Flowchart 500 is described as follows with respect to FIG. 6, which shows operation on row 404 of database file 400, according to an example embodiment of the present invention.

Flowchart 500 begins with step 502. In step 502, a synchronization request is received from the mobile device. For example, as shown in FIG. 3, a synchronization request 310 is received by server 104 from mobile device 102 over link 202.

In step 504, a database object is obtained from a provider that includes a plurality of records. For example, in an embodiment, synchronization module 302 determines that a database object is desired by mobile device 102, as indicated by synchronization request 310. Server 104 transmits channel request 312, which includes a request for a database object. Server 104 receives response 314 from providers 106. Response 314 includes the database object, which may be database file 400 shown in FIG. 4. As shown in FIG. 4, database file 400 includes a plurality of records 402, 404, 406, and 408. In embodiments, the database object can include any number of records.

In step 506, each record of the database object is hashed to calculate a hash result for each record. For illustrative purposes, FIG. 6 shows record 404 of database file 400 being hashed. As shown in FIG. 6, record 404 is input to hashing module 304. Hashing module 304 hashes record 404 to generate/calculate hash result 602. Each record of the database object may be hashed in this manner.

In step 508, the calculated hash result for each record is compared with a corresponding previous hash result, if available. For example, storage 308 stores a previous hash result 604 for record 404. Previous hash result 604 was generated previously. Comparator 306 compares hash result 602 with previous hash result 604 to determine whether record 404 changed since previous hash result 604 was generated.

In step 510, for each record, if the calculated hash result matches the corresponding previous hash result, no update regarding that record of the database object is needed. For example, if comparator 306 determines that hash result 602 matches previous hash result 604, no update to database file 400 of record 404 is needed. Thus, for example, record 404 does not need to be transmitted to mobile device 102 to update database file 400 on mobile device 102. In an embodiment, mobile device 102 may optionally be informed that the particular record (e.g., record 404) does not need an update, although this is not necessary in every embodiment.

In step 512, for each record, if the calculated hash result does not match the corresponding previous hash result or the corresponding previous hash result is not available, the record is transmitted to the mobile device. For example, if comparator 306 determines that hash result 602 does not match previous hash result 604, an update to database file 400 of record 404 is needed. Thus, for example, record 404 (transformed or non-transformed) is transmitted to mobile device 102 to update database file 400 on mobile device 102.

In step 514, for each record, if the calculated hash result does not match the corresponding previous hash result or the corresponding previous hash result is not available, the calculated hash result is stored. Step 514 is optional. For example, if comparator 306 determines that hash result 602 does not match previous hash result 604, or if previous hash result 604 does not exist (e.g., this is a first-time hash for the particular record/database), hash result 604 may be stored in storage 308. Thus, hash result 604 may be used in a future hash as a previous hash result, in a similar manner as previous hash result 604, to determine whether record 404 has been again changed.

Thus, in embodiments where records of a database object are individually hashed, savings in terms of quantities of transferred data may be realized, compared to transferring the entire database object if the database object has any change however small. However, greater numbers of hash results may need to be stored when each record is hashed. Compared to hashing a database object on a field-by-field basis, however, the hashing of records may require transfer of larger quantities of data for records that have changed (instead of transferring only the contents of the changed field), but fewer hash results overall will need to be stored.

### Example Embodiments for Improving Transfer Efficiency with Negative Caching

Embodiments of the present invention are provided in this section for enabling the caching of errors occurring during a synchronization process. These embodiments are provided for illustrative purposes, and are not limiting. Additional operational and structural embodiments for the present invention will be apparent to persons skilled in the relevant art(s) from the description herein. These additional embodiments are within the scope and spirit of the present invention.

According to embodiments of the present invention, errors occurring when attempting to obtain unavailable web content are cached or otherwise stored. Such caching of errors is also referred to as “negative caching.” The cached (stored) errors are subsequently used to avoid spending time on future attempts at obtaining the unavailable web content. Such negative caching may be beneficially used to shorten synchronization times between mobile devices and servers, for example.

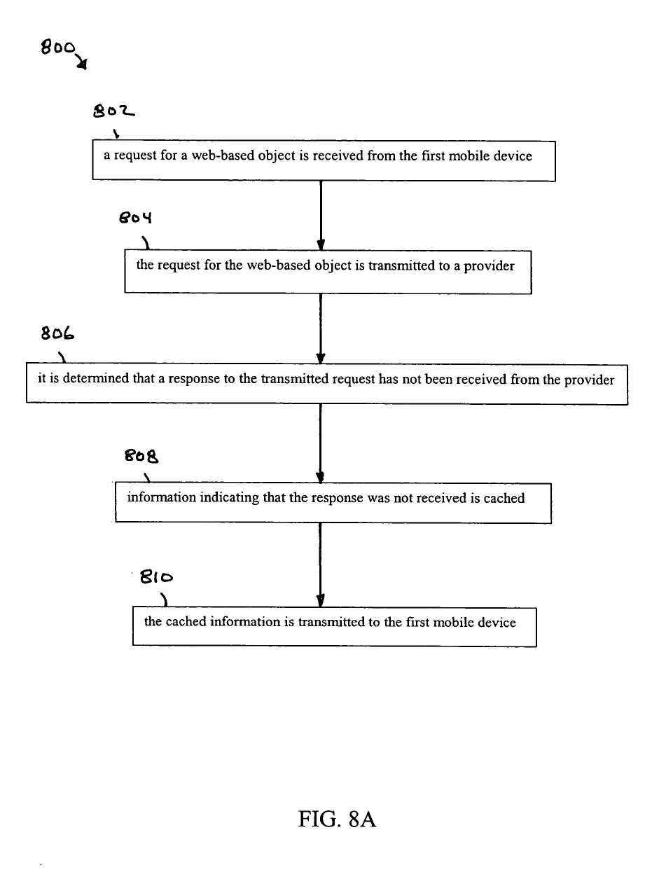

FIG. 7 shows an example server 104, with negative caching capability, according to an embodiment of the present invention. As shown in the embodiment of FIG. 7, server 104 includes a synchronization module 702 and a caching module 704.

Synchronization module 702 operates similarly to synchronization module 302 described above. Caching module 704 caches objects obtained by synchronization module 702 during a synchronization of a mobile device. The cached objects may be used during subsequent synchronizations with mobile devices. For example, caching module 704 may cache web pages requested by a first mobile device, that are obtained by server 104. Server 104 may supply the cached web pages to subsequent mobile devices during subsequent synchronizations. In this manner, server 104 does not need to spend time obtaining the same web page, or other object, from a provider multiple times.

In an embodiment, an object cached by caching module 704 is cleared (e.g., deleted) after a predetermined amount of time. Thus, after clearing, the next time the object is requested by a mobile device, server 104 will need to obtain the object from a provider.

Clearing of objects in caching module can be used to ensure that mobile devices receive up-to-date information. For example, a web page such as www.yahoo.com may be updated on the YAHOO! provider server every 15 minutes. Thus, if www.yahoo.com is obtained by server 104, it may be cached by caching module 704, for subsequent synchronizations, for about 15 minutes. Subsequently, www.yahoo.com may be cleared from server 104 by caching module 704 after 15 minutes, so that an updated version of www.yahoo.com on the YAHOO! provider server may be obtained the next time www.yahoo.com is requested.

As shown in FIG. 7, caching module 704 includes an error caching module 706. Error caching module 706 performs caching of errors (i.e., negative caching) for caching module 704. For example, server 104 may attempt to obtain a web page, such as www.yahoo.com. However, server 104 may not be successful in obtaining the web page. For example, the web page may not be available because the corresponding website is “down” or not accessible, the particular web page may not be available, because of network problems, or because obtaining the web page may take longer than a maximum acceptable predetermined amount of time. In such case, server 104 may receive or produce a web-access error message, such as a “web page not found” type message, or a web-access “timeout” message. In such a case, error caching module 706 caches the error message (or status information indicating the provider is not available), which may be in web page or other form. Thus, in subsequent synchronizations, if the same web object is requested, instead of attempting to obtain the web object, the error message (or other indication of unavailability of the requested provider) may be transmitted to the mobile device. If the mobile device subsequently attempts to access the web object during offline operation, it will instead access the error message, which may be a web page displayed on the mobile device indicating the error.

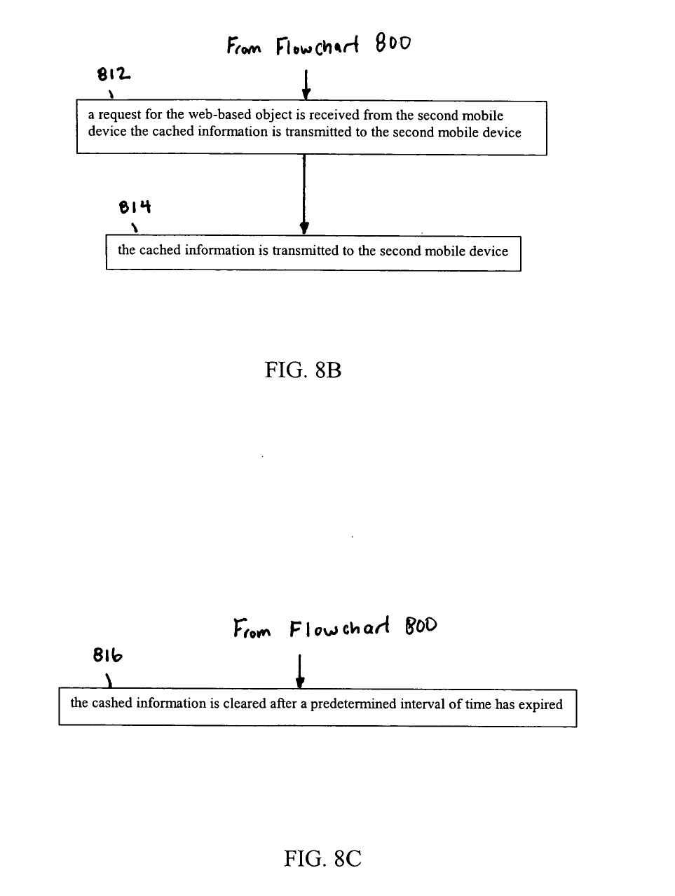

FIGS. 8A-8C show flowcharts providing example steps in a server for synchronizing mobile devices, according to example embodiments of the present invention. For example, in an embodiment, the server may be server 104 shown in FIG. 7. Other structural and operational embodiments will be apparent to persons skilled in the relevant art(s) based on the following discussion. These steps are described in detail below.

Flowchart 800 of FIG. 8A relates to an example synchronization with a first mobile device. Flowchart 800 begins with step 802. In step 802, a request for a web-based object is received from the first mobile device. For example, as shown in FIG. 7, a synchronization request 310 is received by server 104 from the first mobile device over link 202.

In step 804, the request for the web-based object is transmitted to a provider. For example, as shown in FIG. 7, server 104 transmits channel request 312, which includes a request for the web-based object.

In step 806, it is determined that a response to the transmitted request has not been received from the provider. For example, as described above, no response (besides perhaps an error message) is received by server 104 from the provider to channel request 312. In an embodiment, server 104 waits for the response to channel request 312 for a predetermined interval of time without receiving response 312. The predetermined interval of time can be set in server 104 to any length of time. In another embodiment, a web-access error message is received in response to channel request 312, indicating the web-based object is not found or available, that the respective provider server is not responding, or any other applicable error message.

In step 808, information indicating that the response was not received is cached. For example, an error message is cached by error caching module 706, which may cache the error message in the form of a web page. In an embodiment where the error message is in the form of a web page, the web page may have been received over link 108, error caching module 706 may generate the eweb page, or the web page may be otherwise received. Error caching module 706 caches the error message in storage.

In step 810, the cached information is transmitted to the first mobile device. Step 810 is optional. For example, in an embodiment, the cached error message may be transferred to mobile device 102. Thus, when offline, mobile device 102 may view the error message when attempting to view or otherwise interact with the non-received web-based object. The cached information may be transmitted to the mobile device in synchronization response 316, as shown in FIG. 7, for example.

FIG. 8B shows additional steps for flowchart 800. FIG. 8B relates to an example synchronization with a second mobile device. In step 812, a request for the web-based object is received from the second mobile device. Thus, in an embodiment, a second mobile device, which may be a different mobile device or the same mobile device as made the synchronization request in step 802, may attempt to synchronize with server 104. The second mobile device requests the web-based object in a synchronization request, such as a second synchronization request 310.

In step 814, the cached information is transmitted to the second mobile device. For example, in an embodiment, error caching module 706 determines that an error message is cached for the web-based object being requested. Thus, server 104 supplies the cached error message to the second mobile device. The cached error message may transmitted to the second mobile device during the synchronization response (e.g., synchronization response 316) transmitted to the second mobile device, for example.

FIG. 8C shows an additional step for flowchart 800. In step 816, the cashed information is cleared after a predetermined interval of time has expired. For example, in an embodiment, error caching module 706 clears a cached error message after an interval of time since the error message was cached. The interval of time may be any amount of seconds, minutes, hours, etc, as desired, and may be set in error caching module 706. For example, the interval of time may correspond to determined average durations of network outages, average or known time intervals between provider web page refreshes, or may correspond to any other metric known or determined.

In this manner, by caching errors, time of synchronizations between mobile devices and servers can be reduced. For example, a first mobile device may request from server 104 a web-based object that cannot be obtained. Server 104 may timeout from making the request after an interval of a minute of time. Thus, the time for synchronization between the first mobile device and server 104 includes an undesired minute due to the failed request. A subsequent mobile device requesting the web-based object, however, will not suffer the undesired minute, because error caching module 706 will immediately return the cached error message, rather than allowing server 104 to spend another minute attempting to obtain the web-based object. Thus, the time required for the synchronization of the subsequent mobile device, and further mobile devices, will be reduced compared to that for the first mobile device. Therefore, users of mobile devices will spend less time waiting for synchronizations to complete, and will have more time for offline use of the mobile devices.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a server for improved synchronizations with mobile devices, comprising:
synchronizing a first mobile device, including:
(a) receiving a request for a web-based object from the first mobile device;
(b) transmitting the request for the web-based object to a provider;
(c) determining that a response to the transmitted request has not been received from the provider; and
(d) caching information indicating that the response was not received.

2. The method of claim 1, wherein said synchronizing step further comprises:
(e) transmitting the cached information to the first mobile device.

3. The method of claim 1, further comprising:
synchronizing a second mobile device, including:
(a) receiving a request for the web-based object from the second mobile device; and
(b) transmitting the cached information to the second mobile device.

4. The method of claim 1, further comprising:
clearing the cashed information after a predetermined interval of time has expired since the response was determined to have not been received.

5. The method of claim 4, further comprising:
synchronizing a second mobile device, including:
(a) receiving a second request for the web-based object from the second mobile device; and
(b) transmitting the second request for the web-based object to the provider.

6. The method of claim 1, wherein step (c) comprises:
(1) waiting for the response to the transmitted request for a predetermined interval of time without receiving the response during the predetermined interval of time.

7. The method of claim 1, wherein step (c) comprises:
(1) receiving a web-access error message.

8. The method of claim 1, wherein the web-access error message is a web access timeout message, wherein step (1) comprises:
receiving the web-access timeout message.

9. The method of claim 1, wherein the web-access error message is a web page not found message, wherein step (1) comprises:
receiving the web page not found message.

10. The method of claim 2, wherein the cached information is a web page that includes web-access error information, wherein step (e) comprises:
transmitting the web page that includes web-access error information to the mobile device;
wherein a user attempting to access the web-based object on the mobile device displays the web page that includes web-access error information.

11. A web content caching module in a server, wherein the server performs synchronizations with mobile devices, wherein the server receives requests for web-based objects from a mobile device during a synchronization with the mobile device, and transmits the requests to providers, comprising:
an error caching module that caches information related a request for a web-based object transmitted to a provider if a response to the request is not received from the provider;
wherein the server transmits the cached information to the mobile device during the synchronization with the mobile device;
wherein said error caching module clears the cached information after expiration of a predetermined amount of time; and
wherein the server transmits the cached information to another mobile device during a synchronization with the another mobile device if a subsequent request for the web-based object is made by the another mobile device before expiration of the predetermined amount of time.

12. A method in a server for synchronizing the server and a mobile device, comprising:
(a) receiving a synchronization request from the mobile device;
(b) obtaining, responsive to the synchronization request, a database object from a provider that includes a plurality of records;
(c) hashing each record of the database object to calculate a hash result for each record;
(d) comparing the calculated hash result for each record with a corresponding previous hash result, if available;
(e) for each record, if in step (d) the calculated hash result matches the corresponding previous hash result, then determining that no update regarding that record of the database object is needed; and
(f) for each record, if in step (d) the calculated hash result does not match the corresponding previous hash result or the corresponding previous hash result is not available, then transmitting the record to the mobile device.

13. The method of claim 12, further comprising:
(g) for each record, if in step (d) the calculated hash result does not match the corresponding previous hash result or the corresponding previous hash result is not available, then storing the calculated hash result.

14. The method of claim 12, wherein the database object is an Extensible Markup Language (XML) formatted database object, wherein step (b) comprises:
obtaining the XML formatted database object from the provider.

15. The method of claim 12, wherein the database object is a Hypertext Markup Language (HTML) formatted database object, wherein step (b) comprises:
obtaining the HTML formatted database object from the provider.

16. The method of claim 12, wherein the database object is a Standard Generalized Markup Language (SGML) formatted database object, wherein step (b) comprises:
obtaining the SGML formatted database object from the provider.

17. A system in a server for synchronizing the server and a mobile device, comprising:
a synchronization module that receives a synchronization request from the mobile device, and obtains channels from at least one provider due to the synchronization request, wherein an obtained channel includes a database object, wherein the database object includes a plurality of records;
a hashing module that hashes each record of the database object to calculate a hash result for each record; and
a comparator that compares the calculated hash result for each record with a corresponding previous hash result, if available;
wherein for each record, if the calculated hash result matches the corresponding previous hash result, then the synchronization module does not need to transmit an update of that record of the database object to the mobile device in a response to the synchronization request; and
wherein for each record, if the calculated hash result does not match the corresponding previous hash result or the corresponding previous hash result is not available, then the synchronization module transmits the record to the mobile device in a response to the synchronization request.

18. A computer program product comprising a computer useable medium having computer program logic recorded thereon for enabling a processor to perform synchronizations with mobile devices, comprising:
synchronizing means for enabling a processor to synchronize a first mobile device, including:
receiving means for enabling a processor to receive a request for a web-based object from the first mobile device;
transmitting means for enabling a processor to transmit the request for the web-based object to a provider;
determining means for enabling a processor to determine that a response to the transmitted request has not been received from the provider; and
caching means for enabling a processor to cache information indicating that the response was not received.

19. The computer program product of claim 18, wherein said synchronizing means further comprises:
transmitting means for enabling a processor to transmit the cached information to the first mobile device.

20. The computer program product of claim 18, wherein said synchronizing means enables a processor to synchronize a second mobile device, wherein said receiving means enables a processor to receive a request for the web-based object from the second mobile device, and wherein said synchronizing means further comprises:
transmitting means for enabling a processor to transmit the cached information to the second mobile device.

21. The computer program product of claim 18, further comprising:
clearing means for enabling a processor to clear the cashed information after a predetermined interval of time has expired since the response was determined to have not been received.

22. The computer program product of claim 21, wherein said synchronizing means enables a processor to synchronize a second mobile device, wherein said receiving means includes means for enabling a processor to receive a second request for the web-based object from the second mobile device, and wherein said transmitting means includes means for enabling a processor to transmit the second request for the web-based object to the provider.

23. The computer program product of claim 18, wherein said determining means comprises:
waiting means for enabling a processor to wait for the response to the transmitted request for a predetermined interval of time without receiving the response during the predetermined interval of time.

24. The computer program product of claim 18, wherein said determining means comprises:
receiving means for enabling a processor to receive a web-access error message.

25. The computer program product of claim 18, wherein the web-access error message is a web access timeout message, further comprising:
receiving means for enabling a processor to receive the web-access timeout message.

26. The computer program product of claim 18, wherein the web-access error message is a web page not found message, further comprising:
receiving means for enabling a processor to receive the web page not found message.

27. The computer program product of claim 19, wherein the cached information is a web page that includes web-access error information, wherein said cached information transmitting means comprises:
transmitting means for enabling a processor to transmit the web page that includes web-access error information to the mobile device;
wherein a user attempting to access the web-based object on the mobile device displays the web page that includes web-access error information.

28. A computer program product comprising a computer useable medium having computer program logic recorded thereon for enabling a processor to synchronize a server and a mobile device, comprising:
receiving means for enabling a processor to receive a synchronization request from the mobile device;
obtaining means for enabling a processor to obtain, responsive to the synchronization request, a database object from a provider that includes a plurality of records;
hashing means for enabling a processor to hash each record of the database object to calculate a hash result for each record;
comparing means for enabling a processor to compare the calculated hash result for each record with a corresponding previous hash result, if available;
determining means for enabling a processor to determine, for each record, that no update regarding the record of the database object is needed, if the calculated hash result matches the corresponding previous hash result for the record; and
transmitting means for enabling a processor to transmit, for each record, the record to the mobile device, if the calculated hash result does not match the corresponding previous hash result or the corresponding previous hash result is not available for the record.

29. The computer program product of claim 28, further comprising:
storing means for enabling a processor to store the calculated hash result for each record, if the calculated hash result for the record does not match the corresponding previous hash result or the corresponding previous hash result is not available.

30. The computer program product of claim 28, wherein the database object is an Extensible Markup Language (XML) formatted database object, wherein said obtaining means comprises:
obtaining means for enabling a processor to obtain the XML formatted database object from the provider.

31. The computer program product of claim 28, wherein the database object is a Hypertext Markup Language (HTML) formatted database object, wherein said obtaining means comprises:
obtaining means for enabling a processor to obtain the HTML formatted database object from the provider.

32. The computer program product of claim 28, wherein the database object is a Standard Generalized Markup Language (SGML) formatted database object, wherein said obtaining means comprises:
obtaining means for enabling a processor to obtain the SGML formatted database object from the provider.
